(19) United States
(12) Patent Application Publication
(10) Pub. No.: US 2006/0175236 A1
(43) Pub. Date: Aug. 10, 2006

(54) Evaporation of water from concentrated brines and sludges to produce a solid fertilizer product

(76) Inventors: Larry P. Sower, Milford, UT (US); Mary Caroline Sower, Milford, UT (US)

Correspondence Address: John M. Guynn;WORKMAN, NYDEGGER, 1000 Eagle Gate Tower, 60 East South Temple, Salt Lake City, UT, 84111, US

(21) Appl. No.: 11/051,537

(22) Filed: Feb. 4, 2005

(51) Int. Cl. C02F 1/02

(52) U.S. Cl. 210/175

(57) ABSTRACT

A sludge evaporation tunnel and associated method for producing a solid fertilizer product from a sludge. The sludge evaporation tunnel includes a floor surface for supporting a relatively thin layer of sludge from which water is to be evaporated, a cover over the floor for retaining heat and preventing dilution of the sludge layer by rainwater, one or more inlets for introducing sludge into the evaporation tunnel, means for moving and turning over the layer of sludge as water is progressively evaporated from the sludge, and an outlet through which the solid fertilizer product exits. The sludge evaporation tunnel may form part of a larger waste treatment system that includes a digester or anaerobic lagoon, which separates a waste animal slurry into sludge and a dilute waste slurry, and a dilute waste evaporation tunnel.

### BACKGROUND OF THE INVENTION

1. The Field of the Invention

The present invention relates to methods and systems for producing a solid fertilizer product from waste produced from animal raising operations.

2. The Relevant Technology

Feedlots, animal barns, and farms that keep large numbers of animals (e.g., hogs, cattle, poultry, etc.) are sources of enormous quantities of organic waste. Improper disposal of untreated organic waste can cause serious pollution problems. If these pollutants reach bodies of water, either because they leach from disposal sites or as a consequence of being directly released or transported into water bodies, they deoxygenate the receiving waters and impair the receiving waters' capability to support aquatic life.

Acridity and high pathogen content can present additional problems of untreated waste disposal. Acrid gases released into the atmosphere are not only unpleasant but they can also contribute to acid deposition, global greenhouse effects, and ozone depletion.

In hog and cattle raising operations, water is typically used to flush waste out of barns and into storage facilities, thus producing a waste slurry that can be up to 99.5% water. The flushed waste is typically stored in large (e.g., several acres in size) earthen lagoons. Most of the solids settle as a sludge layer at the bottom of the lagoon. A relatively small percentage of nutrients remain dissolved in the dilute layer, while a significant fraction of the nitrogen also volatilizes into the atmosphere.

Lagoons have a limited useful life (e.g., 25 years), and eventually must be cleaned out by completely removing the liquids along with the sludge layer prior to closure. In addition, because of the high costs and environmental disadvantages of operating large lagoons, there has recently been increased pressure to use alternative treatment techniques that either require smaller lagoons or no lagoons at all.

In an attempt to dispose of at least some of the waste while recovering some of the nutrient value of the organic waste material, a slurry of the sludge and liquid is often obtained by mixing the sludge layer with the dilute layer, and then spraying the slurry onto nearby farmland as a liquid fertilizer. Besides the fact that some farms have more waste than can be safely applied to adjacent farmland, land application of such slurry waste can generate offensive odors, and can also contribute to pollution of surrounding groundwater.

Because of the large volume of water used in flushing waste from animal confinement housings into lagoons (or other containing structure), the volume of waste to be treated is increased substantially. The cost effectiveness of waste transportation and waste treatment methods often depends heavily on the volume of waste to be treated.

It would be an improvement in the art to provide a device, method, and system that could be used to produce a solid fertilizer product. It would be a further improvement if such a device, method, and system exhibited low operational and capital costs so as to produce a commercially marketable and profitable solid fertilizer product.

### BRIEF SUMMARY OF THE INVENTION

The present invention is directed to a device, method, and system for producing a solid fertilizer product from animal waste sludges. The device comprises a sludge evaporation tunnel for relatively low temperature production of a solid fertilizer product. The sludge evaporation tunnel includes a floor surface for supporting a relatively thin layer of sludge from which water is to be evaporated, a cover over the floor for retaining heat and preventing dilution of the sludge layer by rainwater, one or more inlets for introducing sludge into the evaporation tunnel, means for moving and turning over the layer of sludge as water is progressively evaporated from the sludge, and an outlet through which the solid fertilizer product may exit.

The evaporation tunnel may be simple in construction. According to one embodiment, the floor may be formed of concrete or other durable surface. According to one embodiment, the cover may be non-permeable. It may be transparent, translucent, or opaque. It may be formed of a plastic polymeric material, e.g., HDPE. Alternatively it may be formed of fabric. According to some embodiments, it may be advantageous for the cover to be formed of an insulative fabric or plastic polymeric material, so as to better retain heat.

The evaporation tunnel may be heated so as to be suitable for year-round operation. According to one embodiment, the tunnel may be heated with warm exhaust air from the animal barns, and/or with warm exhaust air produced through combustion of biogas produced from a digester or an anaerobic lagoon. According to another embodiment, the sludge entering the sludge evaporation tunnel may already be heated, for example, if it has been removed from a digester or anaerobic lagoon operating within a mesophyllic temperature range (e.g., at about 95° F.).

If the evaporation tunnel is heated, it is preferable for it to operate below the decomposition temperature of ammonium bicarbonate, so as to retain this nitrogenous organic fertilizer material within the solid fertilizer product. Ammonium bicarbonate decomposes at about 140° F. The evaporation tunnel is preferably operated within a temperature range between about 70° F. and about 140° F., more preferably between about 90° F. and about 135° F., and most preferably between about 110° F. and about 130° F.

According to one embodiment, the means for moving and turning over the layer of sludge as water is progressively evaporated from the sludge may comprise one or more scraper blades for scraping the sludge off the floor, and turning the sludge over as water is evaporated. The scraper blades progressively move the sludge layer down the length of the evaporation tunnel, turning the sludge material over as it falls over the back of the blade. According to one embodiment, the scraper blades may include a rake for leveling the turned over sludge layer.

The scraper blades may operate continuously, or incrementally (e.g., once each hour), as desired. Either continuous or incremental operation may be achieved with a chain or belt drive mechanism, although other drive mechanisms known in the art may also be used.

The inventive method for producing a solid fertilizer product from a sludge includes the steps of providing a volume of sludge, introducing the sludge into a sludge evaporation tunnel, the sludge evaporation tunnel comprising the structure described above, evaporating at least some water from the volume of sludge as it is turned over and moved along the length of the sludge evaporation tunnel so as to produce a solid fertilizer product, and retrieving the solid fertilizer product as it exits through the sludge evaporation tunnel outlet.

According to one embodiment, the method may further comprise heating the evaporation tunnel so that it operates at a higher than ambient temperature, which allows year round operation.

According to one embodiment, a concentrated waste slurry derived from the dilute portion of waste slurry within a digester or anaerobic lagoon may be mixed with the volume of sludge to yield a sludge mixture prior to introducing the sludge mixture into the sludge evaporation tunnel. For purposes of this disclosure, the term “sludge” includes sludge and sludge mixtures formed by mixing sludge with a concentrated waste slurry.

The residence time of the sludge within the sludge evaporation tunnel is relatively short, which reduces the quantity of dangerous microorganisms that may otherwise grow within the volume of sludge. The residence time of the sludge within the sludge evaporation tunnel is preferably between about 7 and about 21 days, more preferably between about 10 and about 18 days, and most preferably between about 12 and about 16 days.

The inventive method allows for the production of a solid fertilizer product having a desired water content. The solid fertilizer product preferably has a water content between about 3% and about 12% by weight, more preferably between about 5% and about 10% by weight, and most preferably between about 6% and about 8% by weight.

According to one embodiment, the solid fertilizer has an NPK rating of at least about 8:6:6, and more preferably at least about 10:8:8.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a perspective view of an exemplary embodiment of a sludge evaporation tunnel;

FIG. 2 is a close up perspective view of the exemplary scraper blade within the sludge evaporation tunnel of FIG. 1; and

FIG. 3 is a schematic view of a system including an exemplary embodiment of a sludge evaporation tunnel.

### DETAILED DESCRIPTION OF THE PREFERRED EMBODIMENTS

I. Introduction

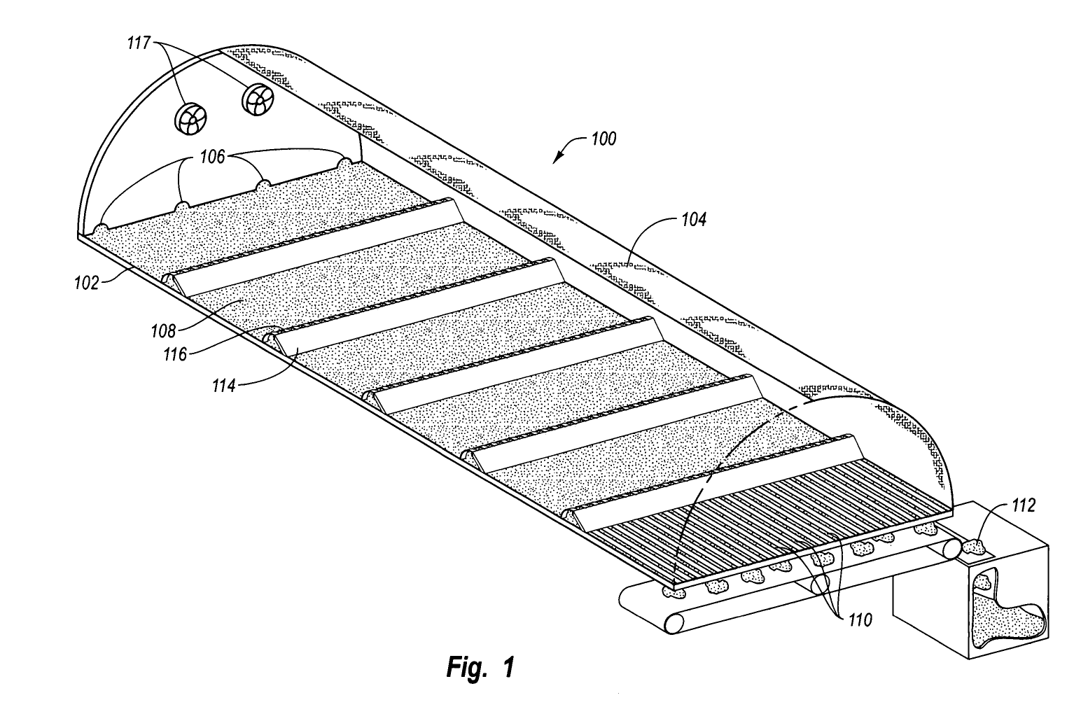

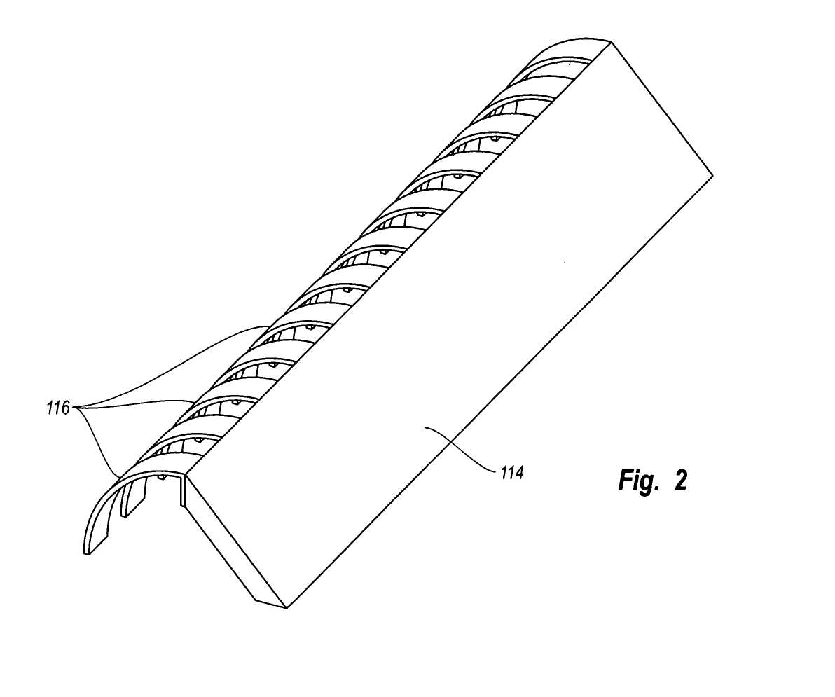

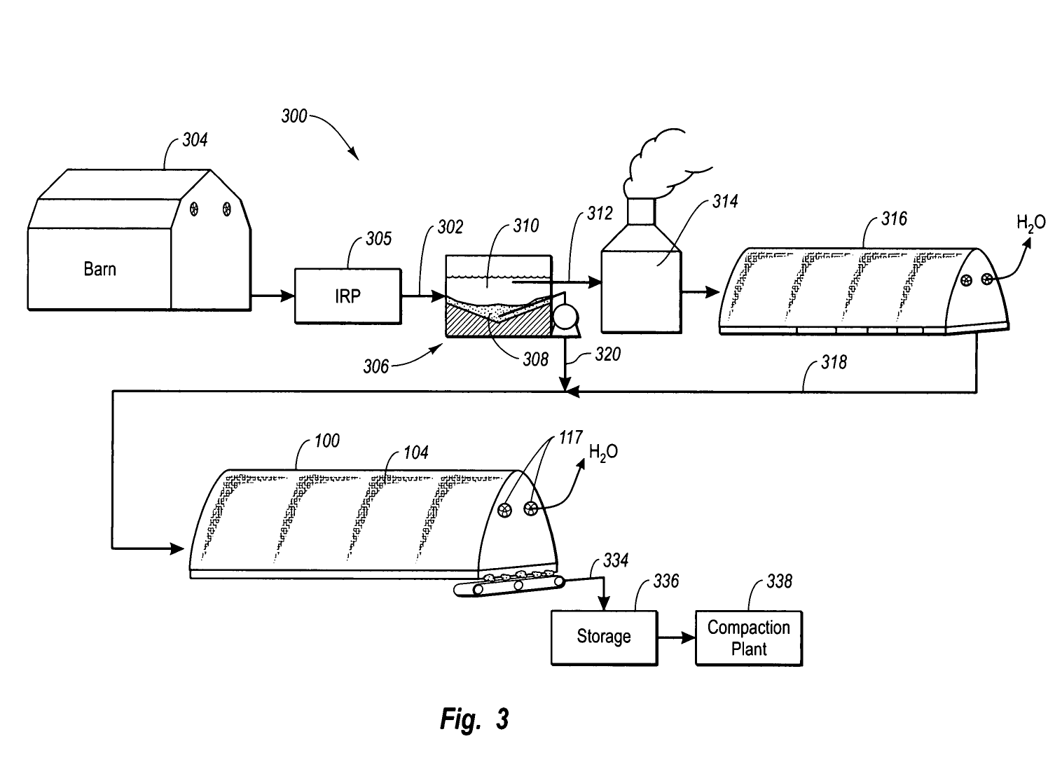

A detailed description of the invention will now be provided with specific reference to FIGS. 1 and 2, which illustrate a preferred embodiment of the invention. FIG. 3, discussed further below, illustrates a preferred embodiment of the invention in the context of a larger system for treatment of a waste slurry produced from an animal confinement housing.

The present invention is directed to a sludge evaporation tunnel and related method for producing a solid fertilizer product from animal waste sludge. The sludge evaporation tunnel includes a floor surface for supporting a relatively thin layer of sludge from which water is to be evaporated, a cover over the floor for retaining heat and preventing dilution of the sludge layer by rainwater, an inlet for introducing sludge into the evaporation tunnel, means for moving and turning over the layer of sludge as water is progressively evaporated from the sludge, and an outlet through which the solid fertilizer product may exit.

II. An Exemplary Sludge Evaporation Tunnel

FIG. 1 illustrates an exemplary sludge evaporation tunnel 100. The sludge evaporation tunnel 100 includes a floor 102, a cover 104 over floor 102, one or more inlets 106 for introducing sludge 108 into evaporation tunnel 100, means for moving and turning over the layer of sludge 108, and an outlet 110 through which solid fertilizer product 112 may exit.

The illustrated sludge evaporation tunnel 100 is simple in construction. Floor 102 may be formed of concrete or another durable material. Cover 104 may be non-permeable. It may be transparent, translucent, or opaque, as desired. The cover 104 may be formed of a plastic polymer material, e.g., HDPE. It may alternatively be formed of fabric. According to some embodiments, cover 104 may be formed of an insulative fabric or polymeric material, so as to better retain heat.

Sludge evaporation tunnel 100 may be heated so as to be suitable for year round operation. According to one embodiment, the tunnel may be heated with warm exhaust air from animal barns, or with warm air produced through combustion of biogas produced from a nearby digester or anaerobic lagoon. According to one embodiment, the sludge entering sludge evaporation tunnel 100 may also be heated. For example, combustion of biogas may be used to maintain a digester or anaerobic lagoon within a mesophyllic temperature range (e.g., 95° F.). Sludge 108 removed from such a digester or anaerobic lagoon would then be at an elevated temperature, e.g., 95° F.

In any case, it is preferable to operate the sludge evaporation tunnel 100 below the decomposition temperature of ammonium bicarbonate (i.e., 140° F.), so as to retain this nitrogenous organic fertilizer material within the solid fertilizer product 112. The sludge evaporation tunnel 100 is preferably operated within a temperature range between about 70° F. and about 140° F., more preferably between about 90° F. and about 135° F., and most preferably between about 110° F. and about 130° F.

In the illustrated embodiment, the means for moving and turning over sludge 108 comprises one or more scraper blades 114 for scraping sludge 108 off of floor 102. The illustrated scraper blades 114 are such that sludge 108 is scraped off floor 102, lifted by blade 114, and then dropped back to floor 102 on the backside of blade 114 so as to be turned over. Turning over the sludge 108 allows for better evaporation of water from sludge 108. As seen in FIGS. 1 and 2, the scraper blades 114 may include a rake 116 attached to the back of blade 114 so as to help level the turned over sludge layer 108. The evaporated water may be exhausted through exhaust fans 117, which may be equipped for variable speed operation so as to provide further control over evaporation within the tunnel 100.

The one or more scraper blades 114 may operate continuously, or incrementally (e.g., once each hour), as desired. Either continuous or incremental operation may be achieved with a chain or belt drive mechanism, although other drive mechanisms known in the art may also be used.

III. An Exemplary Method of Operating a Sludge Evaporation Tunnel

Sludge evaporation tunnel 100 may be used to produce a solid fertilizer product from a sludge. According to one embodiment, the method includes the steps of providing a volume of sludge 108, introducing the sludge 108 into sludge evaporation tunnel 100, evaporating at least some water from the volume of sludge 108 as it is turned over and moved along the length of the sludge evaporation tunnel 100 so as to produce a solid fertilizer product 112, and retrieving the solid fertilizer product 112 as it exits through the sludge evaporation tunnel outlet 110.

The sludge 108 is preferably introduced into sludge evaporation tunnel 100 so as to be in a relatively thin layer, e.g., less than about 2 inches. This allows the sludge material to have greater exposure to surrounding warm air for faster evaporation of water while minimizing growth of any dangerous microorganisms. A thin layer of sludge 108 may be treated relatively quickly, so as to have a relatively short residence time within the sludge evaporation tunnel 100. The residence time of the sludge within the sludge evaporation tunnel is preferably between about 7 and about 21 days, more preferably between about 10 and about 18 days, and most preferably between about 12 and about 16 days.

The inventive method allows for the production of a solid fertilizer product 112 having a desired water content. The solid fertilizer product 112 preferably has a water content between about 3% and about 12% by weight, more preferably between about 5% and about 10% by weight, and most preferably between about 6% and about 8% by weight.

The solid fertilizer preferably has an NPK rating of at least about 8:6:6, and more preferably at least about 10:8:8

III. An Exemplary System Including a Sludge Evaporation Tunnel

Sludge evaporation tunnel 100 will now be described within the context of a larger system for treatment of a waste slurry produced from an animal confinement housing. Although described in such a context, it is to be understood that the inventive sludge evaporation tunnel 100 can be adapted for use in other contexts and systems, including systems for treatment of other animal wastes.

FIG. 3 illustrates an exemplary integrated waste treatment system 300 that includes a sludge evaporation tunnel 100 for producing a solid fertilizer product 334. Waste slurry 302 is flushed from the animal confinement housing 304 into a digester or anaerobic lagoon 306. An internal recycle process (IRP) 305 may be implemented with the animal confinement housing flushing system. Exemplary internal recycle processes are disclosed in U.S. Pat. No. 6,470,828, issued Oct. 29, 2002, and entitled ANIMAL WASTE MANAGEMENT SYSTEM AND METHOD THEREOF, and U.S. application Ser. No. 10/973,104 filed Oct. 25, 2004, and entitled INTERNAL RECYCLE PROCESS FOR HOG WASTE, both of which are hereby incorporated by reference with respect to their disclosure of internal recycle processes. A typical 8000 head grow/finish hog farm produces a waste slurry 302 out of the internal recycle process 305 having a flowrate of about 12,000 gallons per day (gpd).

Once the waste slurry 302 is introduced into the digester or anaerobic lagoon 306, a natural separation occurs. The majority of the solids present in the waste slurry 304 settles into a sludge layer 308 on the bottom of the digester 306, while most of the water, some suspended solids, and a portion of the soluble nutrients remain in solution or suspended above the sludge layer as a dilute waste slurry 310. Digester 306 may include a cover and a biogas collection system for collecting produced biogas, which may be used for heating the digester and other process units as desired.

A portion of dilute waste slurry 310 is removed through a pump (not shown) and associated piping 312 from digester 306. Dilute waste slurry 310 is passed through a heater 314 before being introduced into a dilute waste slurry evaporation tunnel 316. Heater 314 may be fueled with biogas collected from the digester 306. Preheating the dilute waste slurry 310 provides increased rates of evaporation. In order to further heat the dilute waste slurry evaporation tunnel 316, warm air exhaust from the animal barns 304 and the heater 314 may be fed into dilute waste slurry evaporation tunnel 316. The dilute waste slurry evaporation tunnel 316 produces a concentrated waste slurry 318. The dilute waste slurry evaporation tunnel 316 is described in further detail in U.S. application Ser. No. 11/005,085 filed Dec. 6, 2004, and entitled EVAPORATION OF WATER FROM A DILUTE WASTE SLURRY TO PRODUCE A CONCENTRATED WASTE SLURRY, which is hereby incorporated by reference with respect to its disclosure of devices, systems, and methods for producing a concentrated waste slurry.

Sludge 308 is pumped out of digester 306 through a pump and associated piping 320. According to the illustrated embodiment, sludge evaporation tunnel 100 is a simple hoop structure with a cover 104 for promoting evaporation of water from sludge 308 (or a mixture of sludge 308 and concentrated waste slurry 318). Cover 104 prevents rainwater from further diluting the waste to be concentrated, and provides an increased evaporation rate as compared to an evaporator without a cover. The sludge evaporation tunnel 100 is sized according to the required capacity. For example, a typical 8000 head grow/finish hog farm may produce about 12,000 gpd of waste slurry, about 1,500 gpd of that being sludge. According to one such embodiment, sludge evaporation tunnel 100 may be sized so as to process about 1,500 gpd of sludge and about 525 gpd of concentrated waste slurry produced from dilute waste slurry evaporation tunnel 316. Additional capacity may be advantageous where additional sludge is to be processed from traditional lagoons that are being cleaned or are being prepared for closure.

The sludge evaporation tunnel 100 may be sized, configured, and operated so as to evaporate water from the incoming sludge 308 and optionally concentrated waste slurry 318 to produce a solid fertilizer product 334 with a desired water content. Preferably, the solid fertilizer product 334 has a water content between about 3% and about 12% by weight, more preferably about 5% to about 10% by weight, and most preferably about 6% to about 8% by weight.

Solid fertilizer product 334 is removed from the sludge evaporation tunnel 100 and may be stored within storage container 336. The solid fertilizer product 334 has a high nutrient content. According to one embodiment, product 334 has an NPK rating of at least about 8:6:6, and preferably an NPK rating of at least 10:8:8.

According to one embodiment, solid fertilizer product 334 removed from the sludge evaporation tunnel 100 may be characterized as a crumble product. If desired, the crumble product 334 may be sent to a compaction plant 338 for production of a pellet product.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. A sludge evaporation tunnel for relatively low temperature production of a solid fertilizer product from a sludge, comprising:
a floor surface for supporting a layer of sludge from which water is to be evaporated;
a cover over said floor for retaining heat and preventing dilution of the sludge layer by rainwater;
an inlet for introducing sludge into the evaporation tunnel;
means for moving and turning over the layer of sludge as water is progressively evaporated from the sludge; and
an outlet through which a solid fertilizer product is removed.

2. A sludge evaporation tunnel as recited in claim 1, wherein said cover is nonpermeable.

3. A sludge evaporation tunnel as recited in claim 1, wherein said means for moving and turning over the layer of sludge comprises one or more scraper blades for turning over said sludge layer as water is progressively evaporated from the sludge layer.

4. A sludge evaporation tunnel as recited in claim 3, wherein each of said one or more scraper blades further includes a rake for leveling the turned over sludge layer.

5. A sludge evaporation tunnel as recited in claim 1, wherein said evaporation tunnel is heated.

6. A sludge evaporation tunnel as recited in claim 5, wherein said evaporation tunnel operates within a temperature range between about 70° F. and about 140° F.

7. A sludge evaporation tunnel as recited in claim 5, wherein said evaporation tunnel operates within a temperature range between about 90° F. and about 135° F.

8. A sludge evaporation tunnel as recited in claim 5, wherein said evaporation tunnel operates within a temperature range between about 110° F. and about 130° F.

9. A method for producing a solid fertilizer product from a sludge, comprising:
providing an animal waste sludge;
introducing said sludge into a sludge evaporation tunnel as recited in claim 1 through said inlet of said sludge evaporation tunnel;
evaporating at least some water from said sludge as it is turned over and moved along the length of the sludge evaporation tunnel so as to produce a solid fertilizer product; and retrieving said solid fertilizer product as it exits through said outlet.

10. A method as recited in claim 9, further comprising heating said evaporation tunnel.

11. A method as recited in claim 9, further comprising mixing a concentrated waste slurry with said sludge to form a sludge mixture and then introducing said sludge mixture into said sludge evaporation tunnel.

12. A method as recited in claim 9, wherein the residence time of said sludge within said sludge evaporation tunnel is between about 7 and about 21 days.

13. A method as recited in claim 9, wherein the residence time of said sludge within said sludge evaporation tunnel is between about 10 and about 18 days.

14. A method as recited in claim 9, wherein the residence time of said sludge within said sludge evaporation tunnel is between about 12 and about 16 days.

15. A method as recited in claim 9, wherein said solid fertilizer product has a water content between about 3% and about 12% by weight.

16. A method as recited in claim 9, wherein said solid fertilizer product has a water content between about 5% and about 10% by weight.

17. A method as recited in claim 9, wherein said solid fertilizer product has a water content between about 6% and about 8% by weight.

18. A method as recited in claim 9, wherein said solid fertilizer product has an NPK rating of at least about 8:6:6.

19. A method as recited in claim 9, wherein said solid fertilizer product has an NPK rating of at least about 10:8:8.

20. A system for producing a solid fertilizer product from a waste slurry produced and removed from an animal confinement housing, comprising:
at least one of a digester or anaerobic lagoon for containing a waste slurry removed from an animal confinement housing, said waste slurry separating into sludge and dilute waste slurry;
a pump and piping associated with said pump for transporting at least a portion of said dilute waste slurry from said digester or anaerobic lagoon to a dilute waste slurry evaporation tunnel;
a dilute waste slurry evaporation tunnel for evaporating at least some water from said dilute waste slurry so as to produce a concentrated waste slurry;
a pump and piping associated with said pump for transporting at least a portion of said sludge from said digester or anaerobic lagoon to a sludge evaporation tunnel;
a pump and piping associated with said pump for mixing said concentrated waste slurry from said dilute waste slurry evaporation tunnel with said sludge to yield a sludge mixture prior to introducing said sludge mixture into said sludge evaporation tunnel; and
a sludge evaporation tunnel for evaporating at least some water from said sludge mixture so as to produce a solid fertilizer product.

21. A method for producing a solid fertilizer product from a waste slurry produced and removed from an animal confinement housing, comprising:
flushing a waste slurry from an animal confinement housing and into at least one of a digester or an anaerobic lagoon;
allowing said waste slurry to separate into a dilute waste slurry and a sludge;
introducing at least a portion of said dilute waste slurry into a dilute waste slurry evaporation tunnel;
evaporating at least some water from said introduced portion of dilute waste slurry so as to produce a concentrated waste slurry;
removing said sludge from said one of a digester or an anaerobic lagoon and introducing said sludge into a sludge evaporation tunnel;
optionally mixing said concentrated waste slurry from said dilute waste slurry evaporation tunnel with said sludge to form a sludge mixture prior to introducing said sludge mixture into said sludge evaporation tunnel; and
evaporating at least a portion of water from said sludge or sludge mixture so as to produce a solid fertilizer product; and
retrieving said solid fertilizer product as it exits said sludge evaporation tunnel.
